(19) United States
(12) Patent Application Publication
(10) Pub. No.: US 2026/0325954 A1
(43) Pub. Date: Oct. 22, 2026

(54) TUG-OF-WAR TOY WITH PULL STRENGTH INDICATION

(71) Applicant: Sergei Constantine Baranoff, West Sacramento, CA (US)

(72) Inventor: Sergei Constantine Baranoff, West Sacramento, CA (US)

(21) Appl. No.: 19/636,713

(22) Filed: Apr. 1, 2026

Related U.S. Application Data
(60) Provisional application No. 63/790,245, filed on Apr. 17, 2025.

(51) Int. Cl. A63F 9/24; A01K 15/02

(52) U.S. Cl. CPC A63F 9/24; A01K 15/025; A63F 2009/2452; A63F 2009/2454; A63F 2009/247; A63F 2250/10

(57) ABSTRACT

A tug-of-war device comprises an elongated center body with handles attached at opposing ends and a pull sensor positioned between the handles to detect differences in applied pull forces. A processor receives signals from the pull sensor and generates output signals indicating which end experiences larger pull force. A light array changes color responsive to the output signal to visually indicate the winning side, while a speaker generates audible cues corresponding to force dominance. The elongated center body may comprise translucent material covering the light array to create a glowing effect. The device may include wireless connectivity to communicate with external devices and applications for enhanced functionality. Interchangeable handle attachments enable versatility for human-versus-human or human-versus-animal gameplay scenarios.

### CROSS REFERENCE TO RELATED APPLICATIONS

This application claims the benefit of U.S. Provisional Application No. 63/790,245, filed Apr. 17, 2025, which is incorporated by reference in its entirety.

### BACKGROUND

Tug-of-war is a traditional game of strength played by children and adults worldwide, where multiple players pull on opposite ends of a rope to determine which side possesses greater pulling force. Though widely known and enjoyed, limited technological advancements have been made to modernize or digitize this classic game.

Some efforts have been made to enhance the enjoyment of tug-of-war, such as adding gloves and pull straps to the ends of the rope. However, these improvements have not addressed present-day advancements in technology that could provide real-time feedback and analysis of player performance.

Accordingly, there remains a need to provide a method which allows users to easily engage in a game of tug-of-war that analyzes the strength of players and digitally, audibly, and visually advises who is winning the game. Current tug-of-war implementations lack the ability to provide objective, real-time measurement and indication of which side is exerting greater force, leaving players to rely solely on physical displacement of the rope or their opponents to determine the winner.

### SUMMARY

According to an aspect of the invention, a tug-of-war device comprises an elongated center body, a first handle attached at a first end of the elongated center body, a second handle attached at a second end of the elongated center body, a pull sensor positioned within the elongated body between the first handle and the second handle and configured to detect a difference in pull forces applied between the first handle and the second handle, a processor in communication with the pull sensor, wherein the processor is configured to receive a net force signal from the pull sensor and generate, responsive thereto, an output signal indicating which end of the elongated center body is experiencing a larger pull force, a light array in communication with the processor to receive the output signal, the light array configured to change color, responsive to the output signal, indicating which end of the elongated center body is experiencing the larger pull force, and a speaker in communication with the processor to receive the output signal, the speaker configured to generate an audible cue, responsive to the output signal, indicating which end of the elongated center body is experiencing the larger pull force. This system provides real-time digital analysis and feedback to players, enabling objective determination of which side is exerting greater force during gameplay.

According to one or more other embodiments, the tug-of-war device includes one or interchangeable handle attachments, wherein at least one handle comprises a detachable animal toy attachment configured for being gripped or bitten by an animal such as a dog. The detachable handle enables the device to accommodate different types of participants, allowing for human-versus-animal gameplay scenarios while maintaining the same electronic sensing and feedback capabilities for objective measurement of pulling forces between human and animal participants.

### BRIEF DESCRIPTION OF THE DRAWINGS

FIG. 1 shows a tug-of-war device with dual handles and an elongated center body, in accordance with an embodiment.

FIG. 2 shows a block diagram of the internal components of the tug-of-war device, in accordance with an embodiment.

FIG. 3 shows the operational states of the tug-of-war device including neutral, human-side dominant, and opposing side dominant conditions, in accordance with an embodiment.

FIG. 4 shows a flowchart of the method for detecting and indicating pull strength in the tug-of-war device, in accordance with an embodiment.

FIG. 5 shows an alternative embodiment of the tug-of-war device with interchangeable handle attachments.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

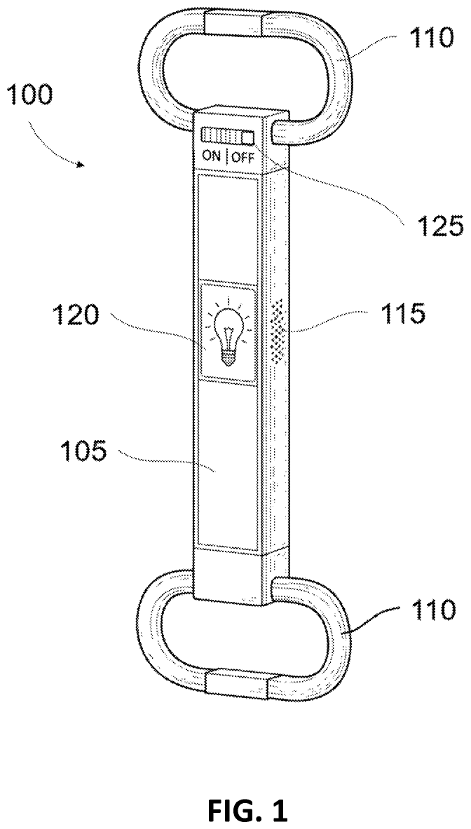

FIG. 1 illustrates an embodiment of a tug-of-war device that provides real-time feedback on pull strength through integrated electronic components. The device comprises an elongated center body 105 that serves as the main structural element housing the internal electronics and connecting the opposing handles. In one embodiment, the elongated center body 105 is constructed with a rectangular cross-section and extends between two handles 110, providing a stable platform for the sensing and feedback systems.

A first handle 110 is attached at one end of the elongated center body 105, and a second handle 110 is attached at another end of the elongated center body 105. Each handle 110 forms a closed loop configuration that allows users to grip and pull the device during gameplay. The handles 110 are securely connected to the elongated center body 105 through integrated attachment points that transfer pulling forces directly to the internal sensing mechanism. This dual-handle arrangement enables two players or teams to engage in competitive pulling while the device monitors the relative forces applied by each side.

The elongated center body 105 incorporates a light cover 120 positioned on its front face, which houses the internal light array and provides visual feedback to players. The light cover 120 may comprise various configurations to enable light transmission from the internal lighting system to be visible externally.

In one embodiment, the light cover 120 features translucent material that allows illumination to pass through while diffusing the light to create a uniform glowing effect. Alternatively, the light cover 120 comprises transparent material that provides direct visibility of the internal light array 215 with minimal optical interference. In another embodiment, the elongated center body 105 may incorporate perforations or apertures positioned strategically to allow focused light beams to emerge at specific locations, creating distinct illumination patterns that indicate which side is exerting greater pulling force. The elongated center body 105 may further include embedded light pipes or optical fibers that channel illumination from the internal light array 215 to predetermined surface locations, enabling precise control of light distribution and visual feedback patterns. In yet another configuration, the elongated center body 105 may feature sections of light-transmissive material integrated within an otherwise opaque housing, creating selective illumination zones that activate based on the competitive state detected by the pull sensor 210.

Adjacent to the light cover 120, a speaker cover 115 is positioned on the elongated center body 105 to house the audio feedback system. The speaker cover 115 includes perforations or acoustic openings that allow sound to emanate from the internal speaker while protecting the electronic components from external elements.

An on/off switch 125 is positioned on the upper portion of the elongated center body 105, providing users with convenient access to power control functionality. The on/off switch 125 allows players to activate or deactivate the electronic systems within the device, conserving battery power when the device is not in use. As depicted, the switch 125 is labeled with “ON” and “OFF” markings to provide intuitive operation for users of all ages.

This configuration creates a self-contained tug-of-war system that modernizes the traditional rope-pulling game by incorporating electronic sensing, processing, and feedback capabilities. Embodiments of the device thus eliminate the need for external ropes or additional equipment while providing objective measurement of pulling forces and immediate feedback to enhance the gaming experience, although the elimination of ropes is not essential. The compact design allows for easy storage and portability while maintaining the competitive dynamics that make tug-of-war an engaging activity.

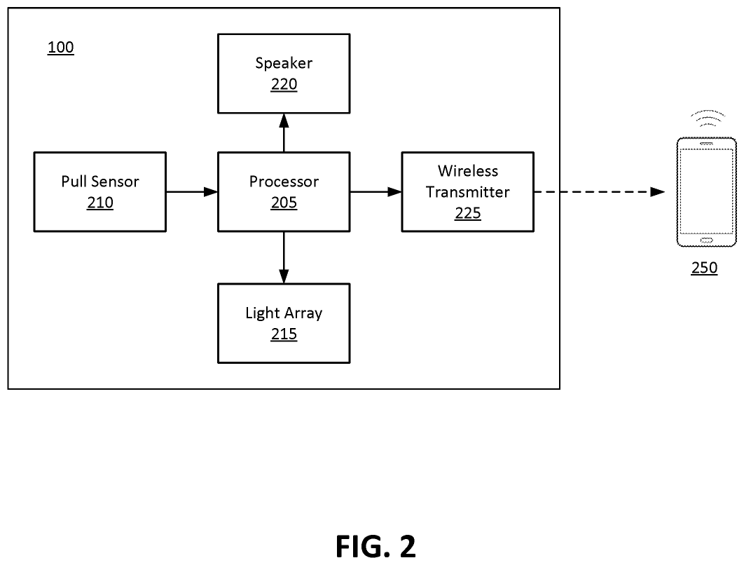

FIG. 2 illustrates a block diagram of the internal electronic components and their interconnections within the tug-of-war device 100. The diagram shows how the various subsystems work together to detect pull forces, process the data, and provide feedback to users through multiple output modalities.

The pull sensor 210 serves as the primary input component, positioned within the elongated center body to detect changes in the device's position or motion that indicate which side is exerting greater pulling force. The pull sensor 210 may comprise an accelerometer configured to detect acceleration of the elongated center body toward one side when that side gains a momentary advantage in the tug-of-war competition. Alternatively, the pull sensor 210 may comprise a displacement sensor configured to measure movement of the elongated center body relative to a neutral position, indicating which direction the device is being pulled. In another embodiment, the pull sensor 210 comprises a position tracking system that monitors the absolute position of the device to determine directional movement toward the dominant side. The pull sensor 210 generates corresponding electrical signals that represent which end of the device is experiencing greater pulling force and communicates directly with the processor 205, transmitting real-time measurement data for analysis and decision-making.

The processor 205 functions as a central control unit that receives input signals from the pull sensor 210 and coordinates all output responses. As discussed herein, the processor 205 may comprise any combination of circuitry, hardware, software, and firmware for carrying out the functionality described herein.

As discussed below, the processor 205 analyzes the force differential data from the pull sensor 210 to determine a current state of the tug-of-war competition, comparing the relative pull strengths to identify which side is dominant. Based on this analysis, the processor 205 generates output signals that are distributed to multiple feedback systems to provide comprehensive user notification.

The speaker 220 receives output signals from the processor 205 and generates audible cues that indicate which end of the device is experiencing the larger pull force. The speaker 220 is positioned within the elongated center body behind the speaker cover and produces distinct sound patterns or tones corresponding to different competitive states, providing immediate audio feedback to players during gameplay.

The light array 215 operates in parallel with the speaker 220, receiving output signals from the processor 205 to provide visual indication of the force differential. The light array 215 may employ any of a variety of methods to indicate which side is winning the tug-of-war competition. In one embodiment, the light array 215 utilizes directional lighting, where different portions of the array illuminate to indicate force dominance. For example, one portion may activate when the corresponding handle experiences greater pulling force, while the other portion illuminates when the other corresponding handle is dominant. In another embodiment, the light array 215 employs color-based indication, where different colors are assigned to each end of the device, with the winning side's designated color being activated to provide clear visual feedback. The light array 215 may also combine both directional lighting and color changes simultaneously, providing enhanced visual feedback with redundant cues that ensure players can easily identify the competitive state. The light array 215 may be configured to change illumination patterns, colors, or intensity based on the processor's analysis of the pull forces, creating visual cues that complement the audio feedback system. The light array 215 may be positioned behind the translucent light cover to create the glowing effect visible on the exterior of the device.

The wireless transmitter 225 provides optional connectivity functionality, receiving output signals from the processor 205 and transmitting state information to an external device 250. The wireless transmitter 225 enables the tug-of-war device to communicate with smartphones, tablets, or other personal electronic devices, allowing for extended functionality such as score tracking, performance analysis, or integration with gaming applications. The external device 250 can receive real-time updates about the competitive state and provide additional features beyond the built-in audio and visual feedback systems.

This interconnected system architecture enables the tug-of-war device to provide immediate, objective feedback about competitive performance while maintaining the option for enhanced digital integration. The multiple feedback modalities ensure that players receive clear indication of the game state through visual, audible, and optionally digital channels, enhancing the traditional tug-of-war experience with modern electronic capabilities.

The external device 250 may execute a dedicated application that receives the output signal from the wireless transmitter 225 and provides enhanced user feedback and functionality beyond the basic audio and visual indicators built into the tug-of-war device. In one or more embodiments, the application processes the real-time competitive state data to display graphical representations of the force differential, showing players visual meters or gauges that indicate the relative pulling strength of each side. The application may maintain score tracking functionality, recording wins and losses for each participant over multiple gaming sessions and providing statistical analysis of performance trends. Additionally, the application may generate haptic feedback through the external device 250, causing the mobile device to vibrate in patterns corresponding to the competitive state, providing tactile confirmation of force dominance changes. The application may also implement achievement systems, unlocking rewards or badges based on performance milestones, and can facilitate multiplayer tournaments by connecting multiple tug-of-war devices through network connectivity. Furthermore, the application may provide coaching features, offering real-time suggestions for improving pulling technique or pacing strategies based on the force measurement data received from the device.

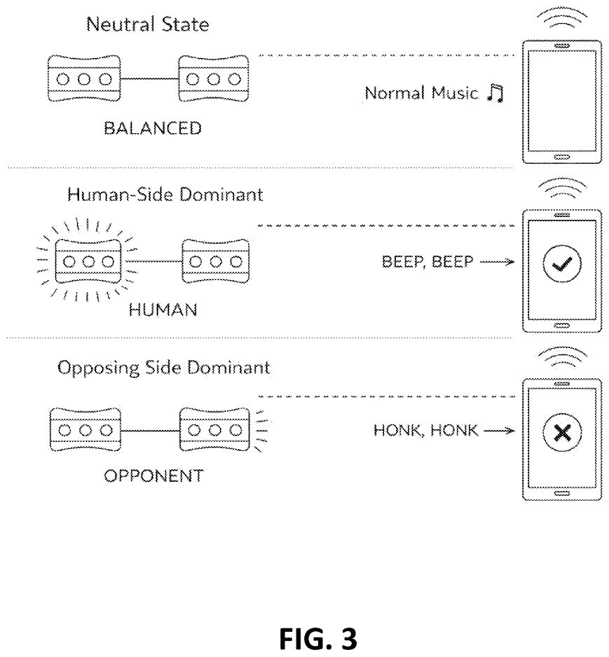

FIG. 3 illustrates an embodiment in which three distinct operational states of the tug-of-war device, according to one or more embodiments, demonstrating how embodiments of the system may provide differentiated feedback based on the relative pull forces detected by the pull sensor 210. This illustrates the device's ability to distinguish between balanced conditions and situations in which one side exerts dominant pulling force, with corresponding visual and audible feedback mechanisms.

In the “Neutral State,” the device operates in a balanced condition where the pull forces applied to both handles are substantially equal. FIG. 3 shows two handle representations in an equilibrium between the opposing forces. During this balanced state, the light array 215 activates a central illumination pattern, and the speaker 220 generates normal background music through the external device 250. This neutral state provides a baseline condition that allows players to understand when the competition is evenly matched, creating a reference point for detecting changes in force differential.

The “Human-Side Dominant” state occurs when the pull force applied to the first handle exceeds the force applied to the second handle by a predetermined threshold. In this configuration, the left handle representation shows radiating lines indicating increased activity and dominance. The processor 205 detects this force imbalance through the pull sensor 210 and activates the corresponding feedback systems. The light array 215 illuminates the left portion of the elongated center body 105, creating a visual indication that the human side is winning. Simultaneously, the speaker 220 generates a distinctive audio pattern (e.g., “BEEP, BEEP”), providing immediate audible confirmation of the human player's advantage. The external device 250 may also display a symbol (e.g., a checkmark), offering additional digital feedback to complement the device's built-in indicators.

The “Opposing Side Dominant” state represents the condition where the second handle experiences greater pulling force than the first handle. FIG. 3 shows the right handle with radiating lines, indicating that the opponent side has achieved dominance in the tug-of-war competition. When the processor 205 determines this state based on input from the pull sensor 210, the light array 215 activates illumination on the right side of the elongated center body 105. The speaker 220 may produce a different audio signature (e.g., “HONK, HONK” sounds), distinguishing this state from the human-dominant condition through unique audible cues. The external device 250 correspondingly displays a symbol (e.g., an “X” mark), providing an indication that the opposing side has gained the advantage.

This multi-state feedback system enables players to understand the competitive dynamics without relying on physical displacement or subjective assessment. The combination of visual light patterns, distinct audio cues, and optional digital display creates a comprehensive feedback mechanism that enhances the traditional tug-of-war experience. The differentiated audio patterns ensure that players can distinguish between winning and losing states even when visual attention is focused on the physical competition, while the wireless connectivity to external device 250 allows for extended functionality such as score tracking or game statistics.

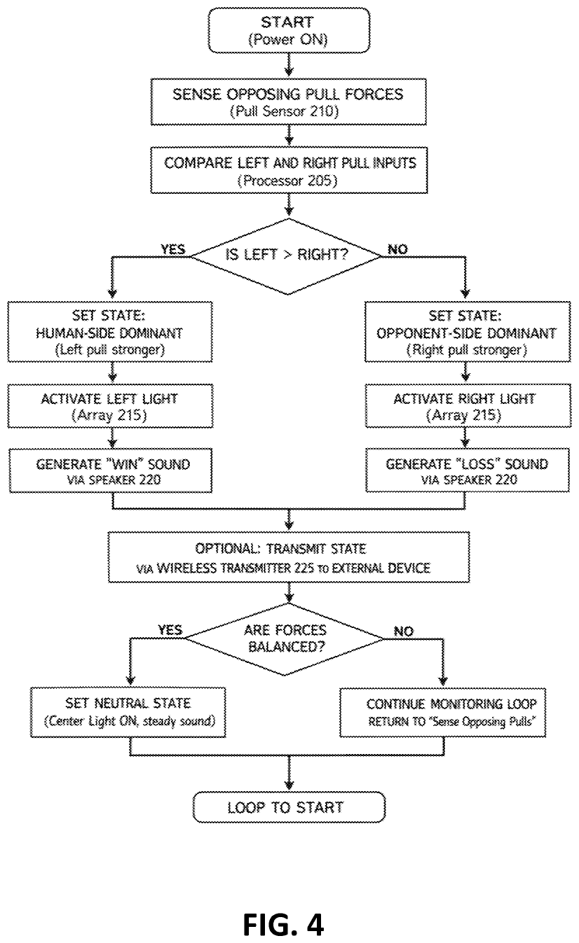

FIG. 4 illustrates a flowchart that describes one or more embodiments of the operational method of the tug-of-war device 100. As illustrated, the device 100 enables a sequential process by which the system detects pull forces, analyzes the data, and provides appropriate feedback to users. this provides a continuous monitoring loop that enables real-time assessment of competitive dynamics during gameplay.

The process begins with the START operation when the device is powered on through the on/off switch 125. Upon initialization, the system proceeds to sense opposing pull forces through the pull sensor 210, which continuously monitors the forces applied to both handles 110. The pull sensor 210 generates electrical signals corresponding to the magnitude and direction of forces detected at each end of the elongated center body 105.

The processor 205 receives the force data from pull sensor 210 and performs a comparison operation to evaluate the left and right pull inputs. This comparison determines the relative strength of the opposing forces and establishes which side is exerting greater pulling force. The processor 205 analyzes the force differential to determine if the left pull force exceeds the right pull force, creating a decision point that drives the subsequent system responses.

When the comparison determines that the left pull force is greater than the right pull force, the system sets the state to “HUMAN-SIDE DOMINANT” indicating that the left pull is stronger. In this condition, the processor 205 activates the left portion of light array 215, creating visual indication that the human side is winning the competition. The system may also generate a “WIN” sound through speaker 220, providing immediate audible feedback to confirm the human player's advantage in the tug-of-war contest.

Conversely, when the right pull force exceeds the left pull force, the system sets the state to “OPPONENT-SIDE DOMINANT,” indicating that the right pull is stronger. The processor 205 responds by activating the right portion of light array 215, providing visual confirmation that the opposing side has gained dominance. The speaker 220 may generate a “LOSS” sound, creating distinct audible feedback that differentiates this state from the human-dominant condition through unique audio cues.

Following the activation of appropriate visual and audible feedback, the system may also transmit the current state information via wireless transmitter 225 to external device 250. This wireless communication enables extended functionality such as score tracking, performance analysis, or integration with mobile applications that can provide additional features beyond the built-in feedback systems.

The process illustrated in FIG. 4 includes a secondary decision point in which the system evaluates whether the forces are balanced. If the pull forces applied to both handles 110 are substantially equal, the system sets a neutral state condition. In this balanced state, the processor 205 activates the center portion of light array 215 and maintains steady background sound through speaker 220, indicating that neither side has achieved dominance, and the competition remains evenly matched.

If the forces are not balanced, the system continues the monitoring loop and returns to the “Sense Opposing Pulls” operation, maintaining continuous surveillance of the competitive dynamics. This continuous monitoring ensures that the system provides real-time feedback as the balance of forces changes during gameplay, allowing players to receive immediate notification of shifts in competitive advantage.

The process as shown concludes with a loop back to the START operation, creating a continuous cycle that maintains ongoing monitoring and feedback throughout the duration of the tug-of-war session. This cyclical operation enables the device to provide consistent, real-time analysis and feedback, enabling players to engage in competitive gameplay with objective measurement of their relative pulling strength and immediate notification of competitive status changes.

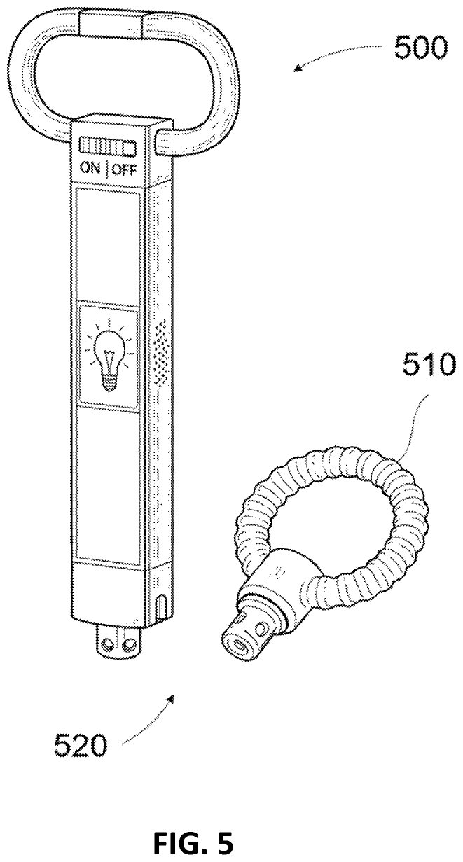

FIG. 5 illustrates an alternative embodiment of the tug-of-war device that demonstrates the modular design capabilities and interchangeable attachment system. This embodiment shows pull toy 500, which may include the same core electronic functionality as the device described in FIG. 1, while providing enhanced versatility through detachable handle components.

In the embodiment depicted in FIG. 5, the pull toy 500 incorporates the same or similar elongated center body configuration with integrated electronic systems, including the pull sensor, processor, light array, and speaker components described in the previous embodiments. The device also includes the ON/OFF switch and light indicator panel, maintaining consistency with the operational interface described in FIG. 1. However, this embodiment demonstrates the device's configurability through the implementation of interchangeable attachment mechanisms.

The pull toy 500 includes a dog pull attachment 510, which comprises a specialized handle module designed specifically for animal interaction during tug-of-war gameplay. In the embodiment shown in FIG. 5, the dog pull attachment 510 features a circular rope configuration with textured surfaces that provide secure grip points for animals, particularly dogs, to bite and pull during competitive play. However, it can be appreciated that any other appropriate shape or configuration suitable for being gripped by a pet can be employed in the dog pull attachment 510. Moreover, in various embodiments, the dog pull attachment 510 can be designed for other types of animals. The attachment 510 may be constructed with durable materials suitable for animal use, and may incorporate safety features to prevent injury during vigorous pulling activities.

The pull toy 500 further includes an attaching mechanism 520 to provide an interface between the pull toy 500 and the dog pull attachment 510, enabling quick and secure connection of different handle modules based on the specific requirements of each gaming session. The attaching mechanism 520 may comprise various configurations to facilitate reliable attachment and detachment of interchangeable components. In one embodiment, the attaching mechanism 520 includes a ball detent system where spring-loaded balls positioned within the elongated center body engage with corresponding recesses or grooves formed in the attachment components, providing secure retention with tactile feedback during connection. In another embodiment, the attaching mechanism 520 comprises a locking ring configuration where a threaded or bayonet-style collar rotates to secure the attachment in place, ensuring stable connection during vigorous pulling activities. The attaching mechanism 520 may be distributed between both components, with portions of the mechanism integrated into the pull toy 500 and complementary portions incorporated into the dog pull attachment 510, creating a two-part system that ensures proper alignment and secure engagement. The attaching mechanism 520 allows users to easily swap between human-oriented handles and animal-specific attachments, expanding the versatility of the device beyond traditional human-versus-human competition to include human-versus-animal gameplay scenarios.

This modular approach enhances the utility of the tug-of-war device 500 by accommodating different types of participants and gaming scenarios. The interchangeable system allows a single device to serve multiple functions, whether for traditional human competition, pet training activities, or interactive play between humans and animals. The attaching mechanism 520 ensures that force transmission from the dog pull attachment 510 to the internal sensing system remains accurate and reliable, maintaining the precision of the pull strength measurement regardless of which attachment module is in use.

The dog pull attachment 510 specifically addresses the growing market for interactive pet toys and training devices, allowing pet owners to engage in competitive play with their animals while receiving objective feedback about the relative pulling forces. This configuration transforms the device from a purely human-oriented gaming system into a versatile tool for pet interaction and training, broadening the potential applications and market appeal of the invention.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure. Specifically, other variations may be included in providing different configurations of the pull sensor 210, processor 205, light array 215, and speaker 220 arrangements, as well as alternative handle 110 and attachment mechanisms.

Moreover, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A tug-of-war device comprising:
an elongated center body;
a first handle attached at a first end of the elongated center body;
a second handle attached at a second end of the elongated center body;
a pull sensor positioned within the elongated body between the first handle and the second handle and configured to detect a difference in pull forces applied between the first handle and the second handle;
a processor in communication with the pull sensor, wherein the processor is configured to receive a net force signal from the pull sensor and generate, responsive thereto, an output signal indicating which end of the elongated center body is experiencing a larger pull force;
a light array in communication with the processor to receive the output signal, the light array configured to change color, responsive to the output signal, indicating which end of the elongated center body is experiencing the larger pull force; and
a speaker in communication with the processor to receive the output signal, the speaker configured to generate an audible cue, responsive to the output signal, indicating which end of the elongated center body is experiencing the larger pull force.

2. The tug-of-war device of claim 1, wherein the center body comprises translucent material covering the light array through which the light array is visible.

3. The tug-of-war device of claim 1, further comprising:
a wireless transmitter coupled with the processor and configured to communicate the output signal to an external device.

4. The tug-of-war device of claim 3, wherein the wireless transmitter comprises a Bluetooth transmitter.

5. The tug-of-war device of claim 3, wherein the external device comprises a personal electronic device configured to run an application associated with the tug-of-war device.

6. The tug-of-war device of claim 1, further comprising:
an on/off switch.

7. The tug-of-war device of claim 1, wherein the first handle comprises a grip to be pulled by a human hand.

8. The tug-of-war device of claim 1, wherein the second handle comprises an animal toy attachment configured for being pulled by an animal.

9. The tug-of-war device of claim 1, wherein the second handle is detachable from the elongated body.

10. The tug-of-war device of claim 1, wherein the light array comprises an LED array.

11. The tug-of-war device of claim 1, wherein the light array is configured to indicate which end of the elongated center body is experiencing the larger pull force by displaying different colors for each end.

12. The tug-of-war device of claim 2, wherein the light array is configured to direct light in a specific direction within the translucent elongated center body to indicate which end is experiencing the larger pull force.

13. The tug-of-war device of claim 1, wherein the light array is configured to indicate a neutral force condition when the pull forces applied to the first handle and the second handle are substantially equal.

14. The tug-of-war device of claim 1, wherein the speaker is configured to play different sounds to indicate which end of the elongated center body is experiencing the larger pull force.
